(19) United States
(12) Patent Application Publication
(10) Pub. No.: US 2002/0150329 A1
(43) Pub. Date: Oct. 17, 2002

(54) Multi-channel wavelength division multiplexer/demultiplexer

(76) Inventors: Joon Tae Ahn, Daejon (KR); Kyong Hon Kim, Daejon (KR); Min Yong Jeon, Daejon (KR); Doo Hee Cho, Daejon (KR); Myung Hyun Lee, Daejon (KR)

Correspondence Address: JACOBSON HOLMAN PLLC, 400 SEVENTH STREET N.W., SUITE 600, WASHINGTON, DC, 20004, US

(21) Appl. No.: 09/940,794

(22) Filed: Aug. 29, 2001

(30) Foreign Application Priority Data
Apr. 4, 2001 (KR) 2001-17918

(51) Int. Cl. G02B 6/293

(52) U.S. Cl. 385/24

(57) ABSTRACT

The present invention relates to a multi-channel wavelength division multiplexer/demultiplexer capable of efficiently coupling or separating wavelength multiplexed optical signals. The multi-channel wavelength division multiplexer/demultiplexer according to the present invention comprises a band splitting means for splitting the band of wavelength multiplexed optical signals (λ₁˜λₙ) into M bands, a demultiplexing means for separating each band split by the band splitting means into a plurality of single wavelength channels, and a multiplexing means for coupling the single wavelength channels separated by the demultiplexing means. Therefore, the present invention can significantly increase the number of available wavelength channels while minimizing optical loss of wavelength channels.

### TECHNICAL FIELD

The invention relates generally to a multi-channel wavelength division multiplexer/demultiplexer. More particularly, the invention relates to a multi-channel wavelength division multiplexer/demultiplexer, which can increase the number of the wavelength channel of inputted wavelength-multiplexed optical signals through a band splitting filter or a 50:50 optical intensity splitter to minimize the optical loss of wavelength channels.

### BACKGROUND OF THE INVENTION

Conventional wavelength division multiplexers/demultiplexers typically used an arrayed waveguide grating (hereinafter called “AWG”), a multi-channel optical filter using a thin film filter, or a cascade type Mach-Zehnder interferometer filter. As the above three types of optical devices used for conventional wavelength division multiplexer/demultiplexer have limited number of channels between 16 channels to 32 channels. Thus, the conventional wavelength division multiplexer/demultiplexer has a problem that it may not meet the need of increased wavelength channels.

Recently, in order to cope with the need for the rapidly-increasing communication traffic, tera-bit optical transmission is required. For this purpose, several hundreds of wavelength channels are also required. Due to this, there is an increasing need for a device that can effectively couple and separate a plurality of wavelength division multiplexed (WDM) optical signals using a single wavelength division multiplexer/demultiplexer having limited number of channels.

FIG. 1 is a block diagram of a conventional single wavelength division demultiplexer. Referring now to FIG. 1, the operation of conventional demultiplexer and multiplexers will be explained below. It can be assumed that the operation and structure of the multiplexer is an inversed version of those of the demultiplexer. Thus, only the operation and structure of the demultiplexer will be explained for simplicity. As shown in FIG. 1, if the WDM optical signals (λ₁˜λₙ) are inputted to the wavelength division demultiplexer 100, the demultiplexer 100 divides the inputted WDM optical signals into respective wavelength and then outputs the results to corresponding output terminals. As this type of the wavelength division multiplexer/demultiplexer has a very limited number (less than 32) of wavelength channels into which the optical signals can be separated, it is difficult for the multiplexer/demultiplexer to handle wavelength optical signals of several hundreds of channels.

As another technology, there is a multi-channel (over 32) wavelength division demultiplexer for overcoming the shortcomings of the single wavelength division demultiplexer as shown in FIG. 1. The multi-channel wavelength division demultiplexer includes one 1×M optical intensity splitter in the conventional single wavelength division demultipliexer, as shown in FIG. 2.

FIG. 2 is a block diagram of a conventional multi-channel wavelength division demultiplexer. The multi-channel wavelength division demultiplexer 220 includes one 1×M optical intensity splitter 210 and the M units of demultiplexers 220. The multi-channel wavelength division demultiplexer divides the wavelength multiplexed optical signals (λ₁˜λₙ) inputted to the 1×M optical intensity splitter 210 into M components according to their light intensity and input the results to the M units of demultiplexer 220. Then, the demultiplexer 220 separates the inputted optical signals into multiple channels (optical signal provided to each channel consists of n wavelength multiplexed optical signals) and then outputs the separated optical signal to corresponding output terminals. Though this type of multi-channel wavelength division demultiplexer can increase number of channels to the number of wavelength channel, there is a disadvantage that optical loss (10×logM) is also increased as the number of channel is increased.

Another technology regarding the wavelength channel selector was disclosed in an article by F. Ebisawa et al., “High speed 32-channel optical wavelength selector using PLC hybrid integration” Proceeding of OFC '99, ThB1, 1999, pp. 8-20. The high-speed 32-channel optical wavelength selector consists of a 32-channel wavelength separator and a wavelength combiner using a single AWG, and the corresponding wavelength channels of the two devices are connected to semiconductor amplifier optical switches. Although this technology constitutes a wavelength channel selector using a single AWG, there is a disadvantage that the number of channel is limited to 32 channels.

### SUMMARY OF THE INVENTION

It is therefore an object of the present invention to unlimitedly extend the number of wavelength channels of continuous wavelength multiplexed optical signal using a optical intensity splitter and a band splitting filter (BSF). Further, the present invention has an object to provide a multi-channel wavelength division multiplexer/demultiplexer capable of significantly increasing the number of available wavelength channels while minimizing optical loss of respective wavelength channels.

In order to accomplish the above objects, present invention provides a multi-channel wavelength division multiplexer/demultiplexer for coupling/separating inputted wavelength multiplexed optical signals characterized by comprising band splitting means for splitting the band of wavelength multiplexed optical signals (λ₁˜λₙ) into M bands, demultiplexing means for separating each band split by the band splitting means into a plurality of single wavelength channels, and multiplexing means for coupling said single wavelength channels separated by said demultiplexing means.

Also, a multi-channel wavelength division multiplexer/demultiplexer for coupling/separating inputted wavelength multiplexed optical signals according to the present invention is characterized in that it comprises optical intensity splitting means for reducing the intensity of inputted wavelength multiplexed optical signals (λ₁˜λₙ) by half, band splitting means for splitting the band of the wavelength multiplexed optical signals provided by the optical intensity splitting means into even-number bands and odd-number bands, demultiplexing means for separating the wavelength channels of each band split by the band splitting means into a plurality of single wavelength channels, and multiplexing means for coupling said single wavelength channels separated by the demultiplexing means.

In another aspect of the invention, the present invention provides a wavelength channel selector for selecting desired wavelength channels from the wavelength channels of inputted wavelength multiplexed optical signals characterized by comprising a band splitting means for splitting the band of wavelength multiplexed optical signals (λ₁˜λₙ) into M bands, a demultiplexing means for separating the wavelength channels of each band split by the band splitting means into a plurality of single wavelength channels, a wavelength channel selecting means for selecting desired single wavelength channels from the wavelength channels separated by the demultiplexing means; and a multiplexing means for coupling the single wavelength channels selected by the wavelength channel selecting means.

### BRIEF DESCRIPTION OF THE DRAWINGS

The aforementioned aspects and other features of the present invention will be explained in the following description, taken in conjunction with the accompanying drawings, wherein:

FIG. 1 is a block diagram of a conventional single wavelength division demultiplexer;

FIG. 2 is a block diagram of a conventional multi-channel wavelength division demultiplexer;

FIG. 3a is a block diagram of a multi-channel wavelength division demultiplexer using an 1×M band splitting filter (BSF) according to one embodiment of the present invention, and FIG. 3b is a diagram illustrating the band pass characteristic of the 1×M BSF shown in FIG. 3a;

FIG. 4a is a block diagram of a multi-channel wavelength division demultiplexer using a 50:50 optical intensity splitter and two BSF's according to another embodiment of the present invention, and FIG. 4b is a diagram illustrating the band pass characteristic of the two BSF's; and

FIGS. 5a and 5b illustrate a wavelength channel selector using a multi-channel wavelength division multiplexer/demultiplexer according to embodiments of the present invention, and FIG. 5c illustrates a detailed structure of the wavelength selectors in FIG. 5b.

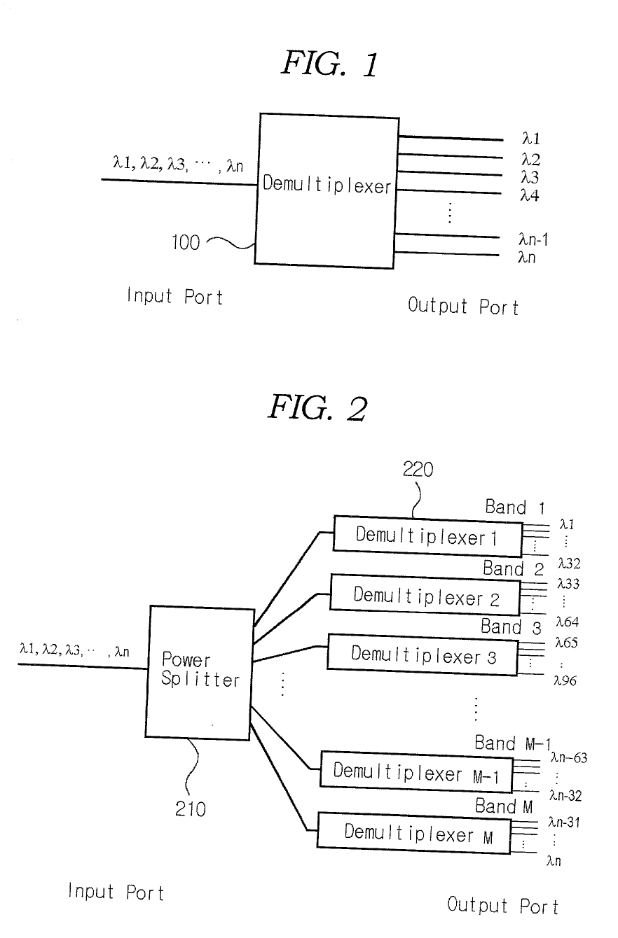

### DETAILED DESCRIPTION OF THE INVENTION

The present invention will be described in detail by way of a preferred embodiment with reference to accompanying drawings, in which like reference numerals are used to identify the same or similar parts.

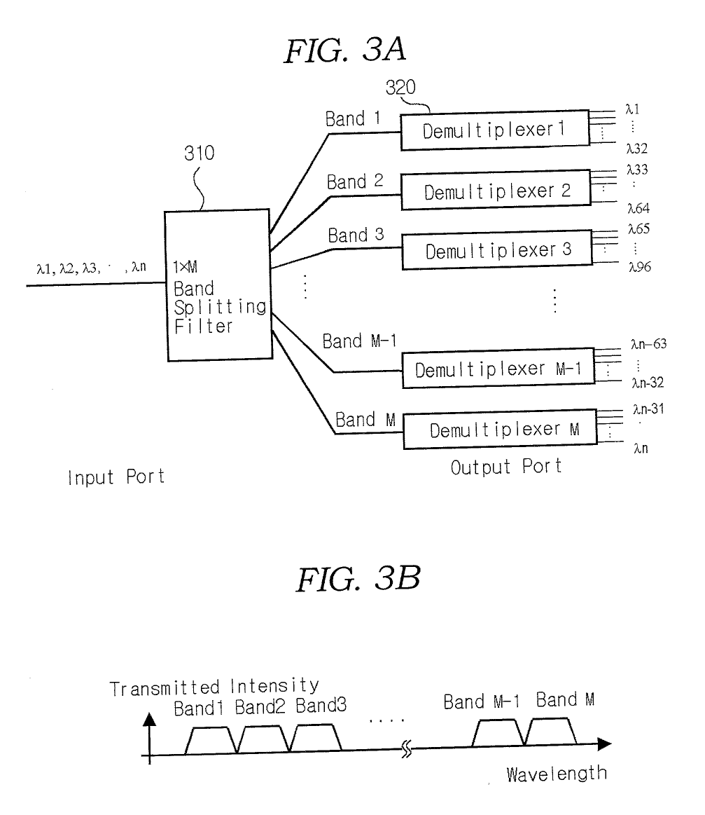

FIG. 3a is a block diagram of a multi-channel wavelength division demultiplexer using a band splitting filter (BSF) according to one embodiment of the present invention, and FIG. 3b is a diagram illustrating the band pass characteristic of the two BSF's shown in FIG. 3a.

The multi-channel wavelength division demultiplexer in FIG. 3a includes an 1×M band splitting filter 310 for dividing the bands of inputted wavelength multiplexed optical signals into M bands, instead of the 1×M optical intensity splitter 210 shown in FIG. 2. The 1×M optical intensity splitter 210, however, can cause more optical loss as the number of wavelength channels increases. Using the band splitting filter in place of the optical intensity splitter, the present invention may prevent the optical loss caused by the increased number of wavelength channels.

The operation of the multi-channel wavelength division demultiplexer having this structure will be explained below. The wavelength division multiplexed optical signals (λ₁˜λₙ) are inputted to the 1×M band splitting filter 310, where they are then separated into M bands. The wavelengths of the optical signals are inputted to the M units of demultiplexers 320, where the optical signals are separated into respective wavelength channels.

The term of “band” used in the present invention means a set of a certain number of different types of continuous single wavelength. For example, a bundle of continuous single wavelengths from wavelength λ₁ to λ₃₂ constitute one band. The present invention assumes that there exist M bands.

FIG. 3b illustrates the band pass characteristic of the 1×M BSF shown in FIG. 3a. As shown in FIG. 3b, in the multi-channel wavelength division demultiplexer using the 1×M band division filter 310, the M band covers the entire wavelength region of the optical signals. Therefore, the multi-channel wavelength division demultiplexer can prevent the loss of input optical signal due to the increased number of channels. In the multi-channel wavelength division demultiplexer in FIG. 3, however, the intensity of the optical signals between wavelength channels may vary due to the low transmitted intensity at the start and end portions of each of band.

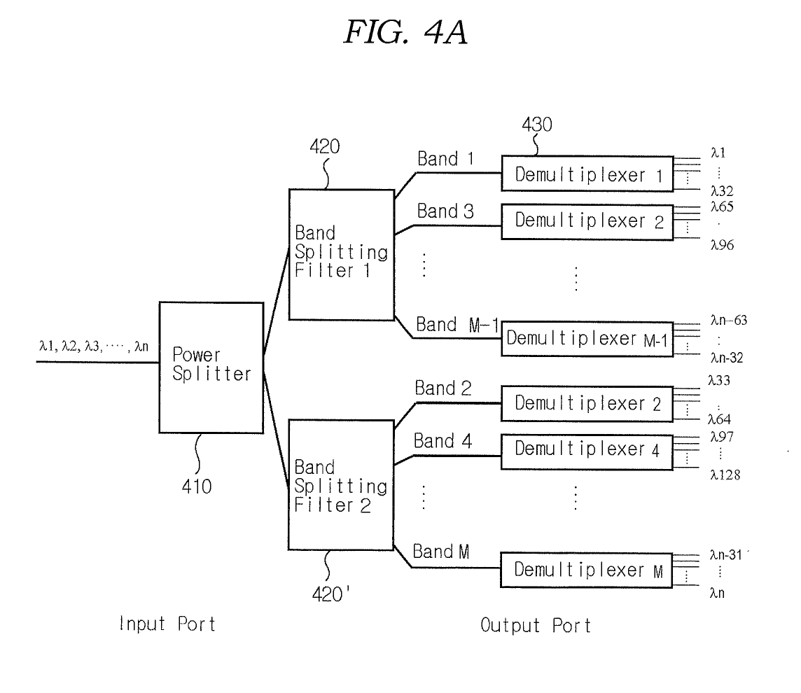

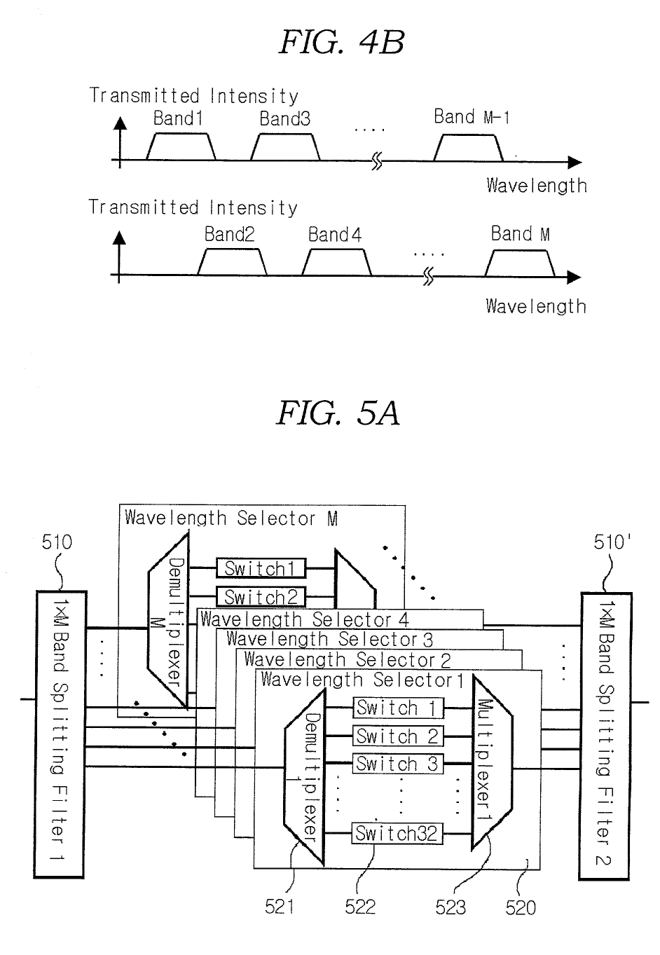

FIG. 4a is a block diagram of a multi-channel wavelength division demultiplexer using a 50:50 optical intensity splitter according to another embodiment of the present invention and FIG. 4b illustrates the band pass characteristic of the BSF1 and the BSF2 of FIG. 4a.

The multi-channel wavelength division demultiplexer according to a second embodiment of the present invention is characterized in that it comprises a single 50:50 optical intensity splitter 410 and two band splitting filters 420 and 420′, compared to the multi-channel wavelength division demultiplexer using the band splitting filter as shown in FIG. 3a.

The operation of the multi-channel wavelength division demultiplexer according to a second embodiment of the present invention will be explained below. First, the intensity of wavelength multiplexed optical signals (λ₁˜λₙ) inputted to the 50:50 optical intensity splitter 410 is bisected as the optical signals pass through the optical intensity splitter 410. Then, the optical signals are respectively inputted to the first and second band splitting filters 420 and 420′. In other words, the wavelength multiplexed optical signals (λ₁˜λₙ) the intensity of which is reduced by half are respectively inputted to the first and second band splitting filter 420 and 420′.

Then, the first and second band splitting filters 420 and 420′ divide the inputted optical signals (λ₁˜λₙ) into each bands. That is, the first band splitting filter 420 divides odd-numbered bands (1, 3, . . . , M-3, M-1) among the entire bands (M) of the inputted optical signals. On the other hand, the second band splitting filter 420′ divides the remaining even-numbered bands (2, 4, . . . , M-3, M) among the entire bands (M) of the inputted optical signals. Therefore, the bands of the inputted wavelength multiplexed optical signals are divided into optical signals of even-numbered bands and odd-numbered bands. Thereafter, the optical signals divided into two types of bands are inputted to the M units of demultiplexer 430. At this time, the optical signals of the even-numbered bands are inputted to the even-numbered demultiplexers while the optical signals of the odd-numbered bands are inputted to the odd-numbered demultiplexers, respectively. Next, the optical signals are separated into respective wavelength channels by the demultiplexers 430.

FIG. 4b illustrates the band pass characteristic characteristic of the BSF1 and BSF2 of FIG. 4a. The multi-channel wavelength division demultiplexer according to a second embodiment of the present invention prevents optical loss occurring at the start and end portions of each bands as shown in FIG. 3b because the band ranges of the optical signals demultiplexed by the odd-numbered and even-numbered demultiplexers partially overlap with each other as shown in FIG. 4b. Thus, the intensity of signals between wavelength channels does not vary. This is because the transmission band of the two band splitting filters 420 and 420′ has an asymmetric characteristic that is wider than a block band.

Although the multi-channel wavelength division demultiplexer having this characteristic prevents a total loss of a certain wavelength signal, it may still cause optical loss of about 3dB due to use of the 50:50 optical intensity splitter 410. However, this is only a theoretical numeral and an actual optical loss becomes the sum of the optical loss of 3dB, the insertion loss due to the band splitting filter, and the insertion loss due to the optical coupler.

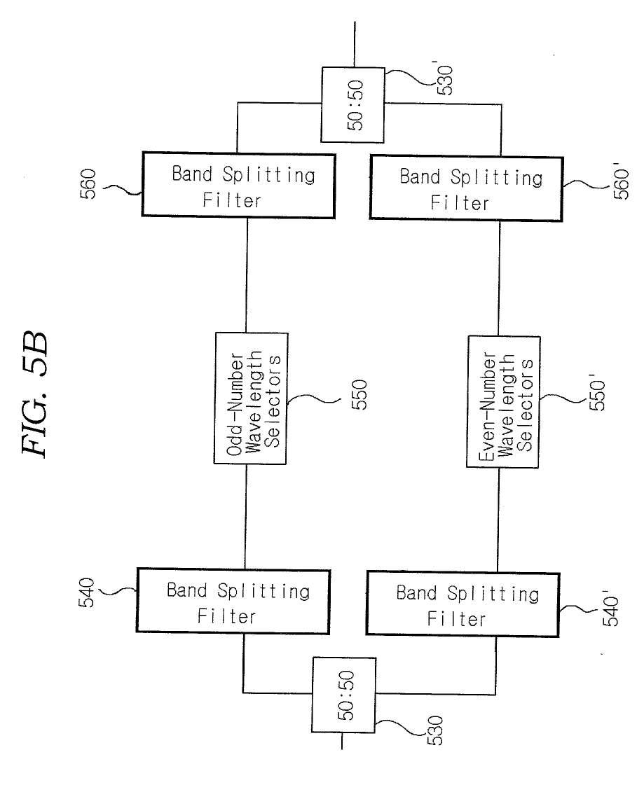

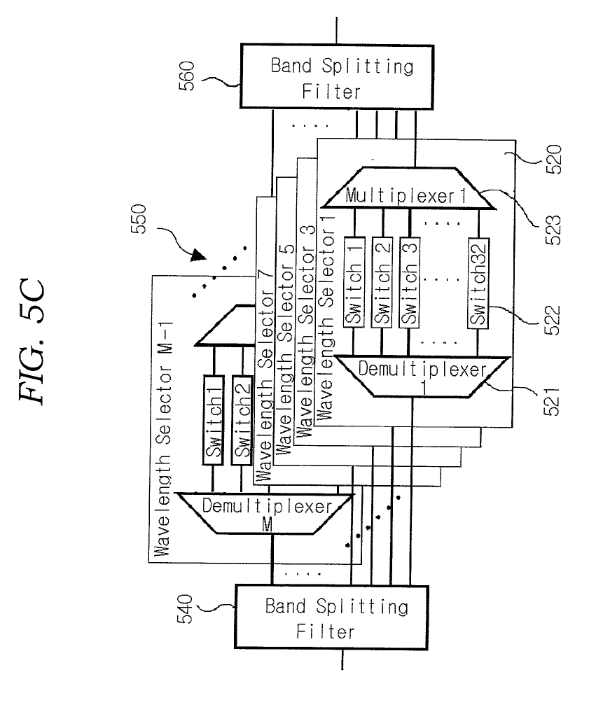

FIGS. 5a and 5b illustrate a wavelength channel selector using the multi-channel wavelength division multiplexer/demultiplexer having the above-mentioned characteristic. FIG. 5a illustrates a wavelength channel selector according to a first embodiment of the present invention using the multi-channel wavelength division multiplexer/demultiplexer shown in FIG. 3a. FIG. 5b illustrates a wavelength channel selector according to a second embodiment of the present invention using the multi-channel wavelength division multiplexer/demultiplexer shown in FIG. 4a.

First, as shown in FIG. 5a, the wavelength channel selector includes two 1×M band splitting filters 510 and 510′ and M units of wavelength selectors 520. Each wavelength selector 520 includes a demultiplexer 521, an optical switch 522 and a multiplexer 523.

The operation of the wavelength channel selector having this structure will be explained below. First, wavelength multiplexed signals inputted to the first band splitting filter 510 are divided into every M bands. At this time, each band consists of different single 32 wavelengths. Then, the even-numbered bands (2, 4, . . . , M-2, M) among the divided bands are inputted to the demultiplexers of corresponding even-numbered wavelength selectors while the odd-numbered bands (1, 3, . . . , M-3, M-1) among the divided bands are inputted to the demultiplexers of corresponding odd-numbered wavelength selectors, respectively. Thereafter, the wavelengths of the optical signals of even-numbered and odd-numbered bands inputted to the demultiplexers are separated into each wavelength channel. Among the optical signals demultiplexed into separate wavelength channels, only wavelength channels selected by the optical switch 522 are outputted. Next, one or more wavelength channels selected in each band are inputted to respective multiplexer 523. The selected wavelength channels of each band are multiplexed for each band by means of the multiplexers 523, so that the wavelength channels selected within the entire bands (even and odd bands) are outputted by the second band splitting filter 510′.

At this time, the 1×M band splitting filters 510 and 510′ used in the wavelength channel selectors having this characteristic may include a thin film interference filter. Also, the wavelength division multiplexer/demultiplexer 521 and 523 may include an AWG, a thin film interference filter, or a Mach-Zehnder interferometer filter connected in series.

FIG. 5b illustrates a wavelength channel selector that has a little optical loss but a good transmission characteristic and that can use all the bands of received wavelength multiplexed optical signals. The wavelength channel selector is different from the wavelength channel selector shown in FIG. 5a in that it comprises 50:50 optical intensity splitters 530 and 530′ and two sets of band splitting filters 540, 540′ and 560, 560′.

The operation of the wavelength channel selector having the above structure will be explained below. First, the intensity of input wavelength multiplexed optical signals is bisected as they pass through the 50:50 optical intensity splitter 530. The optical signals are inputted to two band splitting filters 540, 540′. Each of the band splitting filters 540, 540′ splits the input optical signals into M bands. Preferably, each of M bands consists of 32 different single wavelengths. In FIG. 5b, band splitting filter 540 provides odd-number band to the odd-number wavelength selector 550 and band splitting filter 540 provides even-number band to the even-number wavelength selector 550′.

FIG. 5c illustrates a detailed structure of the odd-number wavelength splitter 550 connected between the band splitting filters 540 and 560. The even-number wavelength splitter 550′ has the same structure as the odd-number wavelength splitter 550, thus the explanation on the even-number wavelength splitter 550′ is omitted.

As shown in FIGS. 5b and 5c, odd-number bands among the M bands divided by the first band splitting filter 540 are inputted to the respective demultiplexers of odd-number wavelength selectors 550. The odd-number wavelength selectors consist of wavelength selectors 1, 3, . . . , M-1 and they respectively receive odd-number bands 1, 3, . . . , M-1 from the band splitting filter 540. In the same manner, even-number wavelength selectors 550′ consist of wavelength selectors 2, 4, . . . , M and they respectively receive even number bands 2, 4, . . . , M from the band splitting filter 540′. Thereafter, each band of optical signals inputted to each of the wavelength selectors are separated into a plurality of wavelength channels (e.g. 32 channels) by a demultiplexer 521. Among the separated single wavelength channels, only one or more single wavelengths selected by the optical switches 552 are outputted. Then, the optical signals for each band consisting of a plurality of thus selected wavelengths are multiplexed by the multiplexer 523 and outputted to corresponding output terminals. Thereafter, the optical signals of each band, which is outputted by multiplexing selected wavelengths, are divided two groups of bands (i.e. optical signals of even-number bands and odd-numbered bands) by means of the two band splitting filters 560, 560′. Then, the intensity of wavelength multiplexed optical signals of even-number bands and odd-number bands provided by the two band splitting filters 560, 560′ is bisected by half while passing through the 50:50 optical intensity splitter 530′. Thus, multiplexed optical signals of a plurality of selected wavelengths are outputted.

The band splitting filters 540, 540′, 560, 560′ used in the wavelength channel selector having this characteristic may use a thin film interference filter. Also, the wavelength division multiplexer/demultiplexer 521 and 523 may use an AWG, a thin film interference filter, or a Mach-Zehnder interference filter connected in series.

As can be understood from the above description, the present invention employs an optical intensity splitter for dividing the intensity of inputted optical signals and two band splitting filters for splitting the inputted optical signals into a plurality of bands. Thus, the present invention can minimize the optical loss of each wavelength channels and loss of certain wavelength signals due to poor transmission characteristic. Further, the present invention can increase the number of available wavelength channels without a limit.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed:

1. A multi-channel wavelength division multiplexer/demultiplexer comprising:
a band splitting means for splitting the band of wavelength multiplexed optical signals (λ₁˜λₙ) into M bands;
a demultiplexing means for separating each band split by said band splitting means into a plurality of single wavelength channels; and
a multiplexing means for coupling said single wavelength channels separated by said demultiplexing means.

2. The multi-channel wavelength division multiplexer/demultiplexer according to claim 1, wherein said band splitting means includes a thin film interference filter.

3. The multi-channel wavelength division multiplexer/demultiplexer according to claim 1, wherein said demultiplexing means and said multiplexing means include an arrayed waveguide grating (AWG) or a Mach-Zehnder interference filter or a thin film interference filter.

4. A multi-channel wavelength division multiplexer/demultiplexer comprising:
an optical intensity splitting means for reducing the intensity of inputted wavelength multiplexed optical signals (λ₁˜λₙ) by half;
a band splitting means for splitting the band of said wavelength multiplexed optical signals provided by said optical intensity splitting means into even-number bands and odd-number bands;
a demultiplexing means for separating the wavelength channels of each band split by said band splitting means into a plurality of single wavelength channels; and
a multiplexing means for coupling said single wavelength channels separated by said demultiplexing means.

5. The multi-channel wavelength division multiplexer/demultiplexer according to claim 4, wherein demultiplexing means includes a first portion for separating the wavelength channels of even-number bands and a second portion for separating the wavelength channels of odd-number bands.

6. The multi-channel wavelength division multiplexer/demultiplexer according to claim 4, wherein said band splitting means includes a thin film interference filter.

7. The multi-channel wavelength division multiplexer/demultiplexer according to claim 4, wherein said demultiplexing means includes an arrayed waveguide grating (AWG) or a Mach-Zehnder interference filter or a thin film interference filter.

8. A wavelength channel selector comprising:
a band splitting means for splitting the band of wavelength multiplexed optical signals (λ₁˜λₙ) into M bands;
a demultiplexing means for separating the wavelength channels of each band split by said band splitting means into a plurality of single wavelength channels;
a wavelength channel selecting means for selecting desired single wavelength channels from the wavelength channels separated by said demultiplexing means; and,
a multiplexing means for coupling said single wavelength channels selected by said wavelength channel selecting means.

9. A wavelength channel selector comprising:
an optical intensity splitting means for reducing the intensity of inputted wavelength multiplexed optical signals (λ₁˜λₙ) by half;
a band splitting means for splitting the band of said wavelength multiplexed optical signals provided by said optical intensity splitting means into even-number bands and odd-number bands; and
a wavelength channel selecting means for selecting desired single wavelength channels from the wavelength channels contained in said band split by said band splitting means,
wherein said wavelength channel selecting means includes a first portion for selecting desired wavelength channels from said even-number bands and a second portion for selecting desired wavelength channels from said odd-number bands.

10. The wavelength channel selector according to claim 9, wherein each portion of said wavelength channel selecting means includes:
a demultiplexer for splitting optical signals in each of said band into a plurality of wavelength channels;
optical switches for selecting only desired wavelength channels from the wavelength channels split by said demultiplexer; and
a multiplexer for coupling said wavelength channels selected by said optical switch.

11. The wavelength channel selector according to claim 9, wherein said band splitting means further includes:
a first band splitting filter for coupling or separating single wavelength channels in the even-number bands, and
a second band splitting filter for coupling or separating single wavelength channels in the odd-number bands.
